(19) United States
(12) Patent Application Publication
(10) Pub. No.: US 2014/0365404 A1
(43) Pub. Date: Dec. 11, 2014

(54) HIGH-LEVEL SPECIALIZATION LANGUAGE FOR SCALABLE SPATIOTEMPORAL PROBABILISTIC MODELS

(71) Applicant: Palo Alto Research Center Incorporated, Palo Alto, CA (US)

(72) Inventors: Evgeniy Bart, Sunnyvale, CA (US); Robert R. Price, Palo Alto, CA (US); Daniel G. Bobrow, Palo Alto, CA (US)

(21) Appl. No.: 13/915,551

(22) Filed: Jun. 11, 2013

(51) Int. Cl. G06N 7/02

(52) U.S. Cl. CPC G06N 7/023
USPC 706/11

(57) ABSTRACT

One embodiment of the present invention provides a system for clustering heterogeneous events using user-provided constraints. During operation, the system estimates, based on a probabilistic model, a distribution of events across clusters such that each cluster includes a set of events. Next, the system estimates a probability distribution for an event property associated with each cluster. The system receives heterogeneous event data, and analyzes the heterogeneous event data to determine the probability distribution of event properties of clusters and to assign events to clusters. The system receives user input specifying the user-provided constraints for specializing the probabilistic model, and performs at least one of: re-computing the assignment of events to clusters, and re-determining the probability distribution of event properties of clusters based on the user input.

### BACKGROUND

1. Field

This disclosure is generally related to analyzing heterogeneous events. More specifically, this disclosure is related to a high-level specialization language that allows non-experts to specify constraints for a specialized probabilistic model.

2. Related Art

For many applications, it is useful to analyze heterogeneous, information-rich events. Heterogeneous events are events that may vary by different factors, including event type, descriptors, location, and time. For example, one type of heterogeneous event can be found in military applications. The military may monitor field operations that produces events such as meetings between people of interest, field reports filed by personnel, images and sounds recorded by equipment deployed in locations of interest, and improvised explosive device (IED) explosions.

Depending on context, analysts may classify events as shallow or deep. Shallow events are those for which relatively little information is available beyond event type, location, and time. Deep events are those for which a rich set of information is available, such as a long field report or a video sequence capturing the event.

Systems for analyzing event data may collect homogenous or heterogeneous event data. When events are homogenous, all events are of the same type (e.g., observing a pine tree of a particular species) and are characterized by the same set of descriptors (e.g. the girth, height, and age of the tree). Another example of a homogenous event is a “check-in” where certain software applications may produce events when users check in to a venue at a certain time and location.

When the events are heterogeneous, multiple event types are present (e.g. meetings, patrols, and IED explosions), and each event is characterized by a potentially different set of descriptors. For example, an IED detonation can be characterized by descriptors such as power and materials used. These descriptors are inapplicable to other events such as meetings between people, which is characterized by a different set of descriptors (e.g., the set of people involved and the meeting duration). Modeling heterogeneous events is particularly important when there are interactions between events (e.g. meetings between suspected terrorists may precede planting an IED).

Modeling languages allows experts to specify models in terms of variables and probability distributions. Modeling languages and frameworks automate training and inference and allow experts to specify a model symbolically or graphically. Experts may tailor probabilistic models to specific applications. Although useful for experts, these tools are typically unsuitable for non-expert users. Users without training in machine learning may find it difficult to express modeling concepts with suitable probability distributions. Furthermore, existing modeling tools may allow users to express models that, although formally correct, are difficult to work with or will not perform what the user has intended.

Some systems allow end-users to select one of a small number of pre-defined models. These models can be completely independent, or may be variations or specializations of each other. The end-user can perform the selection, or the selection process can be automated. However, one drawback of this approach is that users may only select from a small number of models.

Systems such as WinBUGS (Bayesian Inference Using Gibbs Sampling), Just Another Gibbs Sampler (JAGS), and FACTORIE (a toolkit for deployable probabilistic modeling with name derived from the phrase “Factor graphs, Imperative, Extensible”) allow users to specify a probabilistic model and automate inference in the specified model. These systems are very general and allow users to select from a very broad class of models. However, non-experts may find such systems to be difficult to use. In addition, due to their generality, they often cannot take advantage of properties of any specific model and need to resort to inference methods that scale poorly.

### SUMMARY

One embodiment of the present invention provides a system for clustering heterogeneous events using user-provided constraints. During operation, the system estimates, based on a probabilistic model, a distribution of events across clusters such that each cluster includes a set of events. Next, the system estimates a probability distribution for an event property associated with each cluster. The system receives heterogeneous event data, and analyzes the heterogeneous event data to determine the probability distribution of event properties of clusters and to assign events to clusters. The system receives user input specifying the user-provided constraints for specializing the probabilistic model, and performs at least one of: re-computing the assignment of events to clusters, and re-determining the probability distribution of event properties of clusters based on the user input.

In a variation on this embodiment, the user-provided constraints specify that two or more events belong to the same cluster in the probabilistic model.

In a variation on this embodiment, the user-provided constraints specify that events associated with time prior to a particular time are processed according to the probabilistic model, and that events associated with time after the particular time are processed according to another probabilistic model.

In a variation on this embodiment, the user-provided constraints specify that events associated with time prior to a particular time are processed as a first event type, and that events associated with time after the particular time are processed as a second event type.

In a variation on this embodiment, the user-provided constraints specify relationships between variables in the probabilistic model.

In a variation on this embodiment, the system receives user input that specifies parameters associated with events are same when locations associated with the events are the same.

### BRIEF DESCRIPTION OF THE FIGURES

FIG. 1 presents a diagram illustrating a system for collecting and clustering event data, according to an embodiment.

FIG. 2 presents a block diagram illustrating an exemplary probabilistic model for clustering heterogeneous events, according to an embodiment.

FIG. 3 presents a flowchart illustrating an exemplary process for specializing a probabilistic model, according to an embodiment.

FIG. 4 illustrates a computer and communication system for analyzing heterogeneous events, in accordance with one embodiment of the present invention.

FIG. 5 illustrates an exemplary system for specializing probabilistic models, in accordance with one embodiment of the present invention.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention solve the problem of enabling non-expert users to adapt generalized probabilistic models for specialized uses by specializing probabilistic models according to user-provided constraints expressed with a high-level specialization language. Generalized probabilistic models are useful for exploratory analysis, but users may desire to specialize a probabilistic model for particular tasks or to solve particular problems. This disclosure discusses an example of a generalized probabilistic model and shows how non-expert users may utilize a high-level specialization language to express constraints to change the generalized probabilistic model into a specialized probabilistic model.

This disclosure uses an example of a generalized probabilistic model to illustrate how a user may express constraints for the probabilistic model to adapt it for particular tasks. One can model spatial and temporal aspects of events with the disclosed generalized probabilistic model, which facilitates scalable spatiotemporal clustering of heterogeneous events. Using the generalized probabilistic model, one may infer the probability distributions of properties of events associated with clusters and distribution of events among a number of clusters. A cluster of heterogeneous events is a group of events which the model explains using the same probability distribution; such groups of events typically have property values that are likely under the probability distributions of the cluster. A property is, for example, the location or time of an event. By clustering events together, the system allows for detecting interactions between events. For example, one may detect that meetings between suspected terrorists may precede planting an improvised explosive device (IED).

With the generalized probabilistic model disclosed herein, one may utilize standard multivariate probability inference techniques to infer a joint probability distribution. A system can obtain heterogeneous event data, and use standard inference techniques with the probabilistic model to determine the probability distributions of properties of events in clusters and the distribution of events among clusters.

To develop a high-level specialization language for probabilistic models, one initially identifies a family of models that is relatively general. One can then identify specializations of the models that will be scalable and perform to requirements. A developer can then develop a high-level programming language with the capability to describe specializations and allow the end-user to select one of them. This specialization language should allow the user to select from a potentially infinite set of related models.

A user may provide guidance to a model specialization system for specializing a probabilistic model by specifying relationships or properties between variables in the probabilistic model. For example, the user may specify that the system clusters events such that c1=c5=c10, which means that the cluster indexes for event 1, event 5, and event 10 should be the same. In this example, the user requires that the system groups these three events in the same cluster. Note that a user may utilize an editor to specify constraints for the specialized probabilistic model.

Embodiments of the present invention may also support change point models. A change point model is one where statistical distributions/probabilistic models/event types change before and after a particular time. For example, a user may specify a probabilistic model M₁ for events with time prior to time t, and a probabilistic model M₂ for events with time after time t. The user may also specify that the event type is E₁ for events with time prior to time t, and that the event type is E₂ for events with time after time t. Note that the probability distributions may change after time t.

Note that the generalized probabilistic model is a generative model, and belongs to the general family of topic models. One can perform a generative process associated with the generalized model by sampling a cluster, and then sampling an event from the cluster. First, one samples a cluster with an associated index. The clusters correspond to events that co-occur often. Each cluster has a set of parameters ₜthat determine the events that may occur in the cluster, and the properties of these events. For example, a cluster may correspond to “normal activity,” and involves event of type “patrol” and mostly uneventful field reports. Another cluster may correspond to “terrorist activity.” This cluster may include events such as “meetings” (particularly involving suspected terrorists), as well as IED explosions. Different terrorist cells may correspond to different clusters if they differ, for example, in the typical IED types or materials they use.

After sampling the cluster, one can sample an event from the parameters associated with the cluster. For each event, one can sample the event type, as well as parameters such as location, time, properties of the location (for example “urban area” or “rural area”) and the properties of the time (for example, “weekday” or “religious holiday”), and other metadata.

Note that a computing system may utilize the disclosed probabilistic model in a parallel architecture, thereby facilitating analysis of massive data sets.

Although examples are provided herein for a particular generalized probabilistic model, the techniques disclosed herein may also be applied to any other probabilistic model and/or family of probabilistic models.

### System Architecture

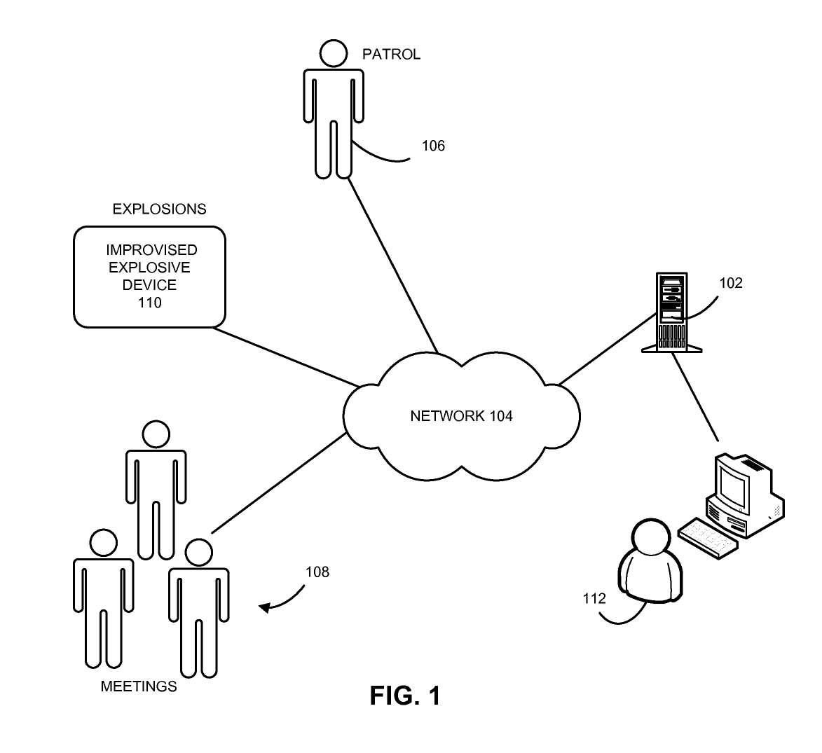

FIG. 1 presents a diagram illustrating a system for collecting and clustering event data, according to an embodiment. In FIG. 1, a server 102 receives event data over a network 104. Various computers and/or other electronic equipment may collect data describing events such as a soldier on patrol 106, terrorists holding a meeting 108, and an explosion from an improvised explosive device 110.

After receiving the event data, server 102 may cluster the heterogeneous events based on a specialized probabilistic model. A user 112 may enter constraints for the probabilistic model using a specialized language. User 112 may view initial clustering results and enter the constraints after viewing the results.

Clustering the heterogeneous events involves determining probability distributions for properties of events in clusters, and also determining distribution of events among clusters. As the system receives events, the system computes probability distributions that converge toward the true distributions associated with the events, or to an appropriate approximation or a bound thereof.

After the system determines the distributions and cluster assignments, they may be utilized to analyze event patterns. The system and/or a human operator may utilize the inferred probability distributions to generate fictional events to predict future events. The system and/or a human operator may also utilize the probability distributions to determine whether two events are caused by the same factor, co-occur often, and to detect outlier events, erroneous observations, and deliberately deceptive observations.

As an example, the system may compute a probability (e.g. p(cᵢ=cⱼ)) to determine whether two events i and j arise from the same cluster to determine whether they are caused by the same factor. The system may also detect outliers or anomalies by finding events with unusually low probabilities under the model. As another example, one can determine the cluster indices that are associated with events occurring at a given location. One can sample additional events from parameters associated with those clusters to predict future events that may occur at those locations.

### Exemplary Probabilistic Model

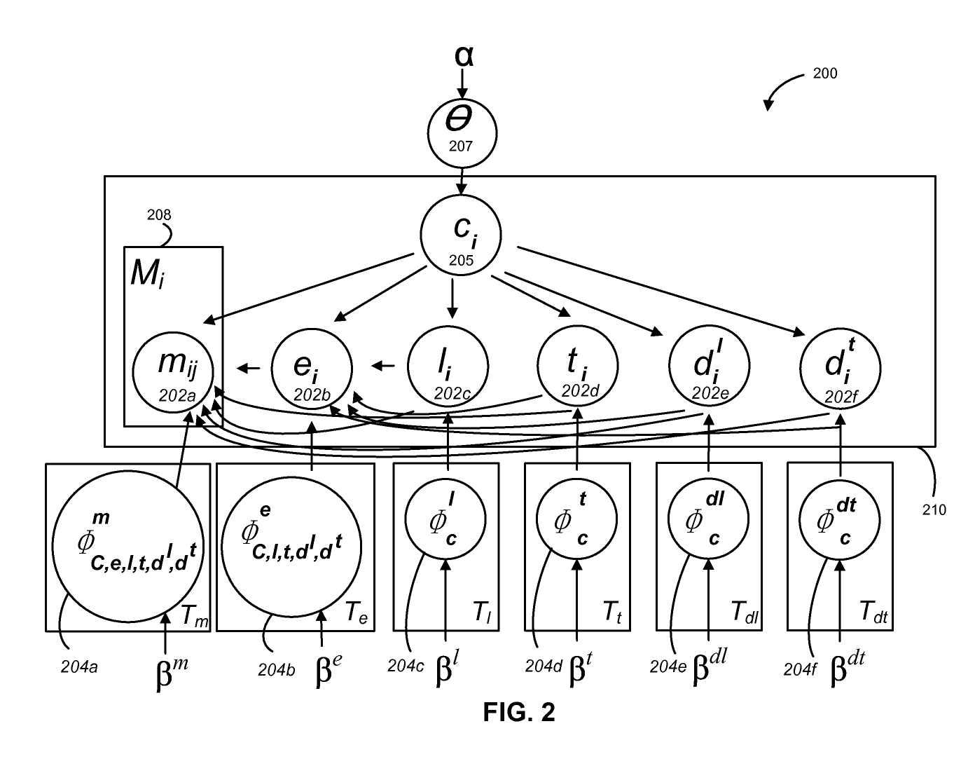

FIG. 2 presents a block diagram illustrating an exemplary probabilistic model for clustering heterogeneous events, according to an embodiment. Embodiments of the present invention include a specialization language for specializing probabilistic models such as the one depicted in FIG. 2. This section describes an exemplary probabilistic model and how to specialize it for specific applications. The probabilistic model 200 of FIG. 2 is illustrated using plate notation. Plate notation is a method of representing variables that repeat in a graphical model. A plate is drawn as a rectangle. Each plate groups variables that repeat together into a subgraph, and a number (e.g., N, T, or Mᵢ) is shown on the plate to represent the number of repetitions of the subgraph in the plate.

The probabilistic model depicted in FIG. 2 illustrates dependency structures between different properties (also called variables) of clusters. Arrows represent dependencies in the diagram. The arrows denote the dependency structure of the probabilistic model. Note that the illustrated model is a generalized version, and one can remove or add dependencies to adapt the model to suit different applications.

In FIG. 2, properties are represented as nodes (e.g., circles). Each node corresponds to a variable in the probabilistic model. Nodes 202a-202f are variables representing properties of observed events. The system receives actual events with properties represented by nodes 202a-202f. Then, based on the properties of the events received, the system determines the probability distributions of the latent variables represented by nodes 204a-204f. The system can determine the joint probability distribution p(θ, cᵢ, eᵢ, lᵢ, tᵢ, φ) for every combination of variable values. Similar to the dependencies, one can change or remove the nodes to adapt to different applications. The other symbols illustrated in FIG. 2 are defined and explained below.

In FIG. 2, α is a hyperparameter. In Bayesian statistics, a hyperparameter is a parameter of a prior distribution. A prior distribution is a probability distribution that expresses one's uncertainty about a parameter or latent variable of a distribution. The prior distribution can be a subjective assessment of an expert, or derived empirically from the data, or can be chosen as non-informative. In this diagram, α represents a parameter of a prior distribution θ, shown as node θ 207.

Node θ 207 represents a prior distribution of the events among the clusters. Node θ 207 represents an estimate of the distribution of events among the clusters prior to observing any actual events (e.g., node θ 207 may be estimated from previous experience). The system determines the prior distribution for node θ 207 based on α. For example, the distribution of events may be 20%, 20%, and 60% among three clusters.

FIG. 2 also depicts a plate 210 representing N events, each event i is associated with six types of random variables and a cluster value cᵢ. The system infers the value of node cᵢ 205, which indicates a cluster that event i belongs to. There are T clusters, and the graph indicates that there are six probability distributions associated with each cluster.

β^{m}, β^{e}, β^{l}, β^{t}, β^{dl}, and β^{dt} are hyperparameters of the corresponding prior distributions. For example, β^{m} represents the hyperparameter for descriptive information associated with an event. β^{e} represents the hyperparameter for the event type property. Usually, the same value of the hyperparameter is used for all clusters c represented by plate Tₑ. Similarly, β^{l} represents the hyperparameters for the location property in a cluster c. β^{t} represents the hyperparameters for the time property in a cluster c. β^{dl} represents the hyperparameters of properties associated with locations. Properties associated with locations may include whether the location is urban, rural, or near or far from the road. β^{dt} represents the hyperparameters of properties associated with time. Properties associated with time may include whether the time is day, night, weekend, or weekday.

The system estimates the posterior property probabilities based on data describing observed events. Nodes mᵢⱼ, eᵢ, lᵢ, tᵢ, dᵢ^{l}, and dᵢ^{t} represent properties of actual events that the system observes. Node mᵢⱼ is located in a descriptive information plate 208 labeled with Mᵢ, and mᵢⱼ represents the descriptive information in a report, an image, video, and/or audio recording. Mᵢ represents repetition over the number of words associated with the descriptive information of event i. Node eᵢ represents the event type. Node lᵢ represents the location of an event i. Node tᵢ represents the time at which the event i occurred. Node dᵢ^{l} represents a property (e.g., urban, rural, or near or far from the road) associated with a location for event i. Node dᵢ^{t} represents a property (e.g., day, night, weekend, or weekday) associated with a time for event i.

The nodes φ represent probability distributions for the properties of events in clusters. The φ nodes are located in plates labeled Tₘ, Tₑ, Tₗ, Tₜ, T_{dl}, and T_{dt}. Tₘ is the number of clusters for the mᵢⱼ property. The appropriate number of clusters for mᵢⱼ is determined by the dependency structure of the model. In one embodiment (illustrated in FIG. 2), mᵢⱼ depends on eᵢ, lᵢ, tᵢ, dᵢ^{l}, and dᵢ^{t}. If eᵢ can take E values, lᵢ can have L values, etc., then the number of clusters for mᵢⱼ is Tₘ=T×E×L×T×D^{l}×D^{t}. If some of the dependencies are removed, the appropriate number of clusters reduces accordingly. Similarly, Tₑ is the number of clusters for the event type property, Tₗ is the number of clusters for the location property, Tₜ is the number of clusters for the time property, T_{dl} is the number of clusters for the properties associated with locations, and T_{dt} is the number of clusters for the properties associated with time.

Node φ_{c,e,l,t,dl,dt}^{m} represents a probability distribution over descriptive information associated with an event. For example, mᵢⱼ may represent the jₜₕ word in the report, or j'th image patch in an image. The variable mᵢⱼ is sampled from a probability distribution with parameters φ_{c,e,l,t,dl,dt}^{m} where c is cᵢ, the cluster index for event i, e is eᵢ, the event type, l is lᵢ, the location, and so on. For text reports, the probability distribution may be categorical (multinomial). For images, the appropriate distribution may also be a multinomial, or, alternatively, normal (Gaussian), according to the type of image information modeled.

Node φ_{c,e,l,t,dl,dt}^{e} represents a probability distribution over the type of events. In some embodiments, this is a categorical distribution since the events belong to separate categories. Examples of event categories include field report, patrol report, and terrorist attack. In other cases, this may be a distribution over a hierarchical structure, to incorporate the possibility that some event types are different but related. For example, event types “patrol report” and “witness report” are different, but have more in common than event types “patrol report” and “IED explosion.”

Node φ_{c}^{l} represents the probability distribution over the location property of events in cluster c. The probability distribution is over a two-dimensional data set of x, y coordinates. The subscript c refers to a cluster index. In one embodiment, this is a normal distribution, and φ_{c}^{l} represents the mean and covariance. In this case, β^{l} represents the parameters of an appropriate prior distribution. In one embodiment, this is a conjugate probability distribution such as a Normal-Inverse-Wishart distribution with parameters β^{l}=(μ₀,κ₀,ν₀,Λ₀).

Node φ_{c}^{t} represents the probability distribution over the time property of events in cluster c. This probability distribution is one-dimensional and continuous.

Node φ_{c}^{dl} represents the distribution of location properties. Such properties of locations include whether the location is urban, rural, or near or far from the road. In one embodiment, this is a categorical (multinomial) distribution.

Node φ_{c}^{dt} represents the probability distribution of time properties. Such time properties include whether the time is day, night, weekend, or weekday. In one embodiment, this is a categorical (multinomial) distribution.

Note that in one embodiment, the system may analyze heterogeneous event data to determine the distribution of event properties associated with clusters using a joint probability distribution that factorizes as follows:

$$p ( θ \vert α ) {\prod }_{i = 1}^{N} p ( {c}_{i} \vert θ ) p ( {d}_{i}^{t} \vert {c}_{i} , {φ}_{c}^{dt} ) p ( {d}_{i}^{l} \vert {c}_{i} , {φ}_{c}^{dl} ) p ( {t}_{i} \vert {c}_{i} , {φ}_{c}^{t} ) p ( {l}_{i} \vert {c}_{i} , {φ}_{c}^{l} ) \times \times p ( {e}_{i} \vert {c}_{i} , {l}_{i} , {t}_{i} , {d}_{i}^{t} , {φ}_{c , l , t , {d}^{l} , {d}^{t}}^{e} ) {\prod }_{j = 1}^{{M}_{i}} p ( {m}_{ij} \vert {c}_{i} , {e}_{i} , {l}_{i} , {t}_{i} , {d}_{i}^{l} , {d}_{i}^{t} {φ}_{c , e , l , t , {d}^{l} , {d}^{t}}^{m} ) \times {Π}_{c , e , l , {d}^{l} , {d}^{t}} p ( {φ}_{c , e , l , t , {d}^{l} , {d}^{t}}^{m} \vert {β}^{m} ) {Π}_{c , l , t , {d}^{l} , {d}^{t}} p ( {φ}_{c , l , t , {d}^{l} , {d}^{t}}^{e} \vert {β}^{e} ) .$$

In one embodiment, a high-level specialization language allows the user to specify constraints between parameters. For example, the user may require a set of parameters to have the same value. In the generalized probabilistic model the distribution for event types depends upon the cluster index as well as location and time. If the user knows that time is irrelevant for a given application (for example, because the situation is stationary over the time period being analyzed), then requiring the parameters be the same across all time values would increase the statistical power of the model and speed up inference. As another example, certain locations may have known types that are associated with certain activities. The system may receive user input that specifies parameters associated with events are the same when locations associated with the events are the same. For example, a user may know that a set of buildings in a town are used as government offices. The user may therefore require parameters of events occurring in these buildings be the same.

### Exemplary Process for Specializing a Probabilistic Model

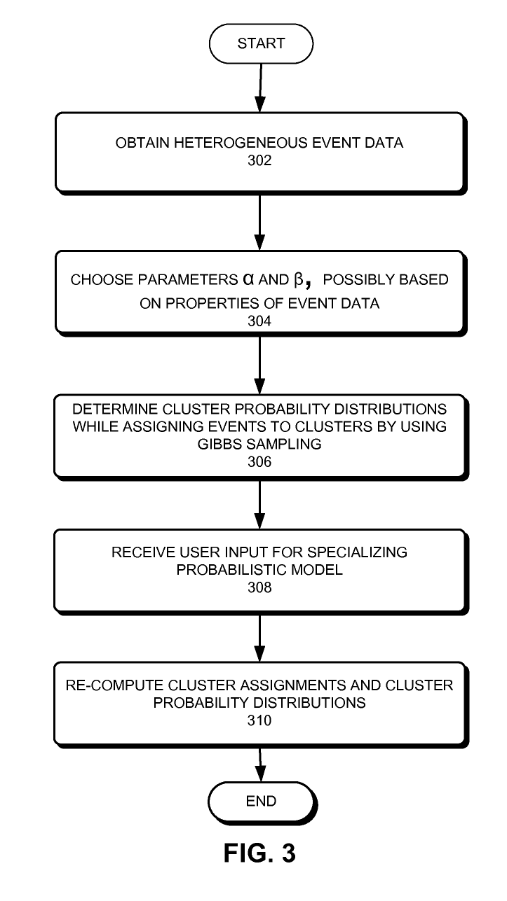

FIG. 3 presents a flowchart illustrating an exemplary process for specializing a probabilistic model, according to an embodiment. During operation, the system initially obtains heterogeneous event data (operation 302). The system may itself collect the event data or obtain the event data from computers with log records or from any machine or person that monitors and collect data on such events. A computer operator may input the event data or the computers may automatically collect such event data. Next, the system chooses parameters α and β, possibly based on properties of the event data (operation 304). The system may obtain both parameters through input from a human operator. The system may also obtain parameters from previously stored data or by generating the parameters. The system then determines cluster probability distributions while simultaneously assigning events to clusters by using Gibbs sampling (operation 306). Note that the system may also use other techniques besides Gibbs sampling. The system outputs a cluster for each event and the probability distribution for properties of events for each cluster.

Next, the system receives user input for specializing the probabilistic model (operation 308). The user may express constraints for specializing the probabilistic model using a high-level specialization language. For example, a user may specify that all events for a cluster share the same location. Based on the user input, the system may re-compute cluster assignments and/or probability distributions for properties of events in clusters (operation 310). The system then outputs a cluster index for each event and the probability distribution for properties of events for each cluster.

To determine cluster probability distributions and assign events to clusters, the system may apply one of the standard inference techniques for graphical models. These techniques include Gibbs sampling and variational inference. Gibbs sampling is a standard method for probabilistic inference. Gibbs sampling is a Markov chain Monte Carlo (MCMC) algorithm for obtaining a sequence of event observations from a multivariate probability distribution (e.g. from the joint probability distribution of two or more variables). The system may utilize this sequence to approximate the joint, conditional, or marginal distributions of interest. Of particular interest are distributed versions of Gibbs sampling, because they allow to speed up inference when multiple processors are available, and can deal with situations where the available data is too big to fit on one machine. Such distributed versions have become available for topic models such as Spatio-Temporal latent Dirichlet allocation (ST-LDA), but not for models previously used for spatiotemporal clustering. With variational inference, the system approximates the posterior distribution over a set of unobserved variables given some data (e.g., approximating the property and event distributions after observing the event evidence).

Note that embodiments of the present invention are not limited to utilizing Gibbs sampling or variational inference, and the system may also utilize other algorithms for inference.

After determining the probability distributions of the clusters, the system may gauge the accuracy of the probabilistic model. The system can generate instances of events from the inferred probabilities, and compare the generated events to the actual events to determine whether the model is accurate.

### Exemplary System

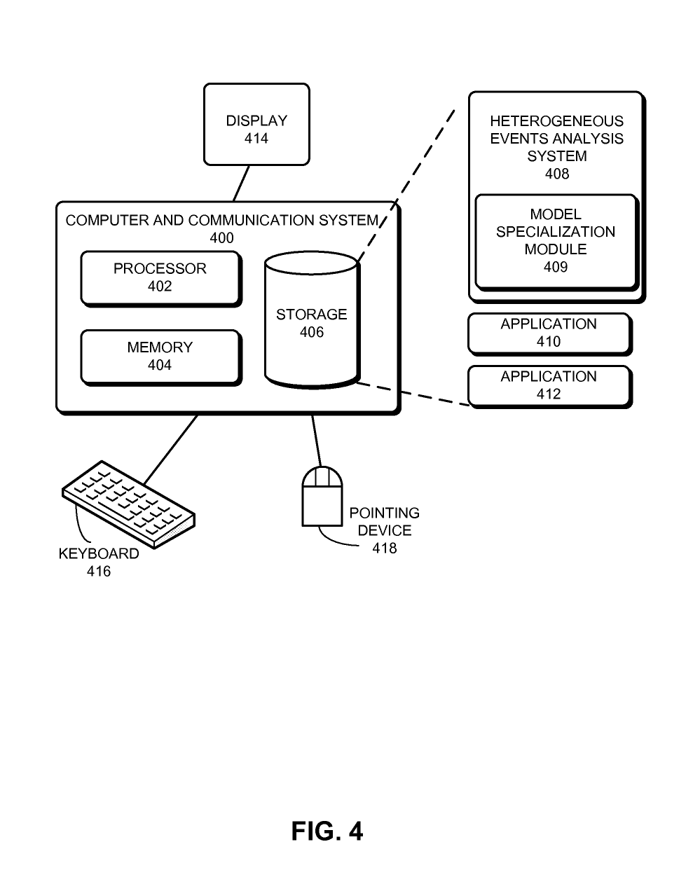

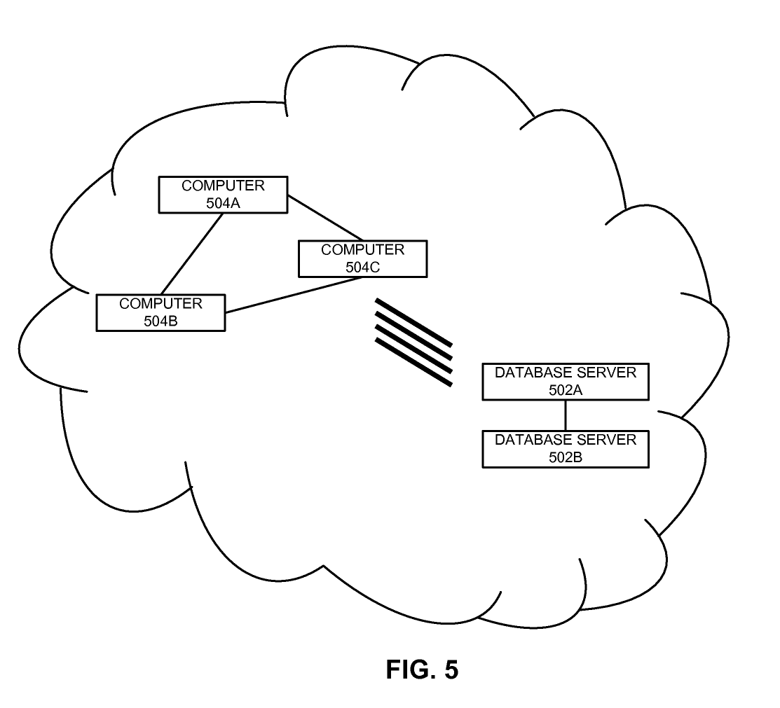

FIG. 5 illustrates an exemplary system for specializing probabilistic models, in accordance with one embodiment of the present invention. In one embodiment, a number of computers that include communication systems are connected in a network, sometimes called “cloud” or “cluster.” Some computers function as database servers 502a, 502b and provide access to a set of collected heterogeneous events. Other computers 504a, 504b, 504c implement a distributed version of Gibbs sampling for the purpose of performing inference over this dataset. Each computer is structured as shown in FIG. 4.

In FIG. 4, a computer and communication system 400 includes a processor 402, a memory 404, and a storage device 406. Storage device 406 stores a number of applications, such as applications 410 and 412. Storage device 406 also stores a heterogeneous events analysis system 408 and a model specialization module 409. Model specialization module 409 includes language parsing routines and other logic to process user input for specializing probabilistic models. During operation, one or more applications, such as heterogeneous events analysis system 408, are loaded from storage device 406 into memory 404 and then executed by processor 402. While executing the program, processor 402 performs the aforementioned functions. In the course of program execution, communication between various computers takes place. Compute servers (e.g., computers 504a, 504b, 504c) communicate with database servers 502a, 502b to obtain heterogeneous event data stored in database servers 502a, 502b. Compute servers also communicate with other compute servers as appropriate in order to implement the distributed Gibbs sampling algorithm. Each computer and communication system 400 is coupled to an optional display 414, keyboard 416, and pointing device 418.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-executable method performed by a system for clustering heterogeneous events using user-provided constraints, comprising:
estimating, based on a probabilistic model, a distribution of events across clusters such that each cluster includes a set of events;
estimating a probability distribution for an event property associated with each cluster;
receiving heterogeneous event data;
analyzing the heterogeneous event data to determine the probability distribution of event properties of clusters and to assign events to clusters;
receiving user input specifying the user-provided constraints for specializing the probabilistic model; and
performing at least one of:
re-computing the assignment of events to clusters; and
re-determining the probability distribution of event properties of clusters based on the user input.

2. The method of claim 1, wherein the user-provided constraints specify that two or more events belong to the same cluster in the probabilistic model.

3. The method of claim 1, wherein the user-provided constraints specify that events associated with time prior to a particular time are processed according to the probabilistic model, and that events associated with time after the particular time are processed according to another probabilistic model.

4. The method of claim 1, wherein the user-provided constraints specify that events associated with time prior to a particular time are processed as a first event type, and that events associated with time after the particular time are processed as a second event type.

5. The method of claim 1, wherein the user-provided constraints specify relationships between variables in the probabilistic model.

6. The method of claim 1, further comprising receiving user input that specifies parameters associated with events are same when locations associated with the events are the same.

7. A computer-readable storage medium storing instructions that when executed by a computer cause the computer to perform a method for clustering heterogeneous events using user-provided constraints, the method comprising:
estimating, based on a probabilistic model, a distribution of events across clusters such that each cluster includes a set of events;
estimating a probability distribution for an event property associated with each cluster;
receiving heterogeneous event data;
analyzing the heterogeneous event data to determine the probability distribution of event properties of clusters and to assign events to clusters;
receiving user input specifying the user-provided constraints for specializing the probabilistic model; and
performing at least one of:
re-computing the assignment of events to clusters; and
re-determining the probability distribution of event properties of clusters based on the user input.

8. The computer-readable storage medium of claim 7, wherein the user-provided constraints specify that two or more events belong to the same cluster in the probabilistic model.

9. The computer-readable storage medium of claim 7, wherein the user-provided constraints specify that events associated with time prior to a particular time are processed according to the probabilistic model, and that events associated with time after the particular time are processed according to another probabilistic model.

10. The computer-readable storage medium of claim 7, wherein the user-provided constraints specify that events associated with time prior to a particular time are processed as a first event type, and that events associated with time after the particular time are processed as a second event type.

11. The computer-readable storage medium of claim 7, wherein the user-provided constraints specify relationships between variables in the probabilistic model.

12. The computer-readable storage medium of claim 7, wherein the computer-readable storage medium stores additional instructions that, when executed, cause the computer to perform additional steps comprising:
receiving user input that specifies parameters associated with events are same when locations associated with the events are the same.

13. A computing system for clustering heterogeneous events using user-provided constraints, the system comprising:
one or more processors,
a computer-readable medium coupled to the one or more processors having instructions stored thereon that, when executed by the one or more processors, cause the one or more processors to perform operations comprising:
estimating, based on a probabilistic model, a distribution of events across clusters such that each cluster includes a set of events;
estimating a probability distribution for an event property associated with each cluster;
receiving heterogeneous event data;
analyzing the heterogeneous event data to determine the probability distribution of event properties of clusters and to assign events to clusters;
receiving user input specifying the user-provided constraints for specializing the probabilistic model; and
performing at least one of:
re-computing the assignment of events to clusters; and
re-determining the probability distribution of event properties of clusters based on the user input.

14. The computing system of claim 13, wherein the user-provided constraints specify that two or more events belong to the same cluster in the probabilistic model.

15. The computing system of claim 13, wherein the user-provided constraints specify that events associated with time prior to a particular time are processed according to the probabilistic model, and that events associated with time after the particular time are processed according to another probabilistic model.

16. The computing system of claim 13, wherein the user-provided constraints specify that events associated with time prior to a particular time are processed as a first event type, and that events associated with time after the particular time are processed as a second event type.

17. The computing system of claim 13, wherein the user-provided constraints specify relationships between variables in the probabilistic model.

18. The computing system of claim 13, further comprising receiving user input that specifies parameters associated with events are same when locations associated with the events are the same.
